(19) United States
(12) Patent Application Publication
(10) Pub. No.: US 2014/0117103 A1
(43) Pub. Date: May 1, 2014

(54) THERMOSTAT AND HOUSING FOR THERMOSTAT

(71) Applicants: Mauro Antonio Rossi, Caxias do Sul (BR); Daniel Jocemar Rodrigues, Caxias do Sul (BR); Leandro José Balardin, Sao Marcos (BR); Roniclei Giacomin dos Santos, Caxias do Sul (BR)

(72) Inventors: Mauro Antonio Rossi, Caxias do Sul (BR); Daniel Jocemar Rodrigues, Caxias do Sul (BR); Leandro José Balardin, Sao Marcos (BR); Roniclei Giacomin dos Santos, Caxias do Sul (BR)

(21) Appl. No.: 13/663,112

(22) Filed: Oct. 29, 2012

(51) Int. Cl. G05D 23/12; G05D 99/00

(52) U.S. Cl. 236/99 R; 29/428

(57) ABSTRACT

A thermostat is provided that includes a housing, a temperature sensor assembly, a switching arrangement and an adjustment shaft is provided. The housing includes a generally L-shaped main body attached to a generally U-shaped cover. The temperature sensor assembly includes a bellows operably fluidly attached to a capillary tube. The bellows and capillary tube define a sealed cavity storing a working fluid. The switching arrangement is operably actuated by the temperature sensor assembly to open and close a circuit as a result of changes in temperature of the working fluid. The adjustment shaft is configured to adjust a temperature set point at which the temperature sensor assembly actuates the switching arrangement. The adjustment shaft extends through the housing. Methods of assembly of the thermostat are also provided.

### FIELD OF THE INVENTION

This invention generally relates to thermostats for appliances such as refrigerators or freezers and particularly to housings for thermostats.

### BACKGROUND OF THE INVENTION

Thermostats for appliances such as refrigerators or freezers are used to control a compressor that adjusts the temperature of the temperature controlled environment of the appliance, e.g. where the food or other product is stored. The thermostat typically includes a housing, a temperature sensor assembly, a switching arrangement, and an adjustment mechanism for adjusting when the thermostat will turn on and/or turn off a compressor for adjusting the temperature within the temperature controlled environment.

Due to increasing costs of manufacturing and materials, it is desired to provide for simplified assembly and reduced component costs. Embodiments of the present invention provide improvements over the current state of the art of thermostats.

### BRIEF SUMMARY OF THE INVENTION

Embodiments of the invention aim to provide a new and improved thermostat that reduces the number of components and/or reduces the cost of assembly and manufacturing.

In one embodiment, the new and improved thermostat utilizes a new and improved housing that reduces part cost and assembly costs. In a particular embodiment, a thermostat including a housing, a temperature sensor assembly, a switching arrangement and an adjustment shaft is provided. The housing includes a generally L-shaped main body attached to a generally U-shaped cover to define an internal cavity. The L-shaped main body and U-shaped cover will form a generally cube shaped housing that is easily assembled and manufactured to reduce part costs. The temperature sensor assembly includes a bellows operably fluidly attached to a capillary tube. The bellows and capillary tube define a sealed cavity storing a working fluid that will drive the bellows due to changes in the temperature of the working fluid. The switching arrangement is operably actuated by the temperature sensor assembly to open and close a circuit as a result of changes in temperature of the working fluid. By opening and closing the circuit, a compressor can be turned on and off to adjust the temperature of the temperature controlled environment. The adjustment shaft is configured to adjust a temperature set point at which the temperature sensor assembly actuates the switching arrangement. The adjustment shaft extends through the housing.

In a particular embodiment, the U-shaped cover includes a first side portion, a second side portion and a base portion. The first and second side portions are operably coupled to one another by the base portion to form the U-shape with an opening formed between the first and second side portions. The L-shaped main body includes a bellows plate portion and a first leg portion that extends at an angle relative to the bellows plate portion, typically about a ninety degree angle. When assembled, the housing defines a generally open side that is opposite the side provided by the bellows plate portion.

In one embodiment, the first and second side portions extend outward from an inner surface of the base portion and define free distal edges that are spaced away from the base portion. In an assembled state, the first leg portion of the main body is positioned adjacent the free distal edges of the first and second side portions and a free distal edge of the bellows plate portion is positioned adjacent the base portion.

In one embodiment, each of the first and second side portions includes at least one connecting tab extending from a first edge that extends between the free distal edge and the base portion of corresponding side portion. The bellows plate portion includes a corresponding aperture configured to receive a corresponding one of the connecting tabs therethrough. In the assembled state, the connecting tabs are plastically bent inward and over an outer surface of the bellows plate portion to secure the main body to the cover.

In one embodiment, the thermostat further includes a switch base attached to the housing adjacent the open side of the housing. Each of the first and second side portions of the cover includes at least one switch base connecting tab extending from a second edge, opposite the first edge. The switch base includes a corresponding connecting lug for each of the switch base connecting tabs. The connecting lugs extend outward from corresponding sides of the switch base. In the assembled state, the switch base connecting tabs are plastically bent around the corresponding connecting lugs to secure the switch base to the housing.

In one embodiment, each side portion of the cover includes at least one laterally outward extending locating tab that tapers outward when moving in a direction extending away from the base, an end of the locating tabs being farthest from the base portion of the cover defining an abutment for locating the housing during installation.

In one embodiment, the base portion includes an embossed region that extends laterally outward and away from the distal free edges of the side portions. The embossed region defines an aperture through which the adjustment shaft extends and in which the adjustment shaft is rotatable about an adjustment shaft axis. The embossed region includes a laterally inward extending projection. The adjustment shaft includes a radially outward extending tab that extends radially outward beyond the inward extending projection. The tab of the adjustment shaft angularly abutting the laterally inward extending projection at a limit of the rotation of the adjustment shaft relative to the cover.

In one embodiment, the cover includes a pair of mounting wings. The mounting wings extend laterally outward beyond edges of the side portions. The mounting wings are configured to cooperate with an attachment mechanism, e.g. a screw, bolt, clip, etc. to secure the thermostat to an appliance, and typically within an opening in a panel of the appliance.

In one embodiment, at least one of the side portions includes a laterally outward offset ground terminal formed therein. The ground terminal is a continuous piece of material with the rest of the corresponding side portion. Typically, the cover and the main body will be formed from stamped sheet metal.

In one embodiment, the bellows portion includes bent reinforcement flaps forming opposed edges of the bellows plate portion that extend away from the leg portion of the main body. The reinforcement flaps are spaced laterally apart from one another a distance greater than the first and second side portions of the cover. The first and second side portions of the cover being received between the reinforcement flaps when the housing is in an assembled state such that each reinforcement flap overlaps the outer surface of the adjacent one of the first and second side portions.

In another embodiment, a thermostat including a housing, a switching arrangement, a temperature sensor assembly, and an adjustment shaft is provided. The switching arrangement is configured to open and close a circuit. The temperature sensor assembly includes a bellows operably fluidly attached to a capillary tube. The bellows and capillary tube define a sealed cavity storing a working fluid, typically a gas. The temperature sensor assembly is configured to actuate the switching arrangement as a result of changes in temperature of the working fluid. The adjustment shaft is configured to adjust a temperature at which the temperature sensor actuates the switching arrangement. The adjustment shaft extends through the housing. The adjustment shaft includes a recess defining a radially inward facing cam surface that bounds the recess. The radially inward facing cam surface has a varying radius relative to a rotational axis of the adjustment shaft. The switching arrangement includes a cam follower that cooperates with the cam surface to adjust a temperature setting at which the temperature sensor actuates the switching arrangement.

In one embodiment, the adjustment shaft includes an enlarged portion that is sized larger than an aperture in the housing through which the adjustment shaft extends. The enlarged portion has a top surface that abuts an inner surface of the housing surrounding the aperture. The recess of the adjustment shaft that receives the cam follower of the switching arrangement is formed through an opposite end of the enlarged portion.

In one embodiment, the adjustment shaft includes a reduced diameter cylindrical portion axially offset from the enlarged portion along the rotational axis. The reduced diameter cylindrical portion is sized to mate with the aperture through the housing.

In one embodiment, the thermostat further includes a bush beaded to the cover. The adjustment shaft extending through the bush. The bush includes an enlarged cylindrical portion that is sized larger than an aperture in the housing through which the adjustment shaft extends. This portion abuts an outer surface of the housing. The bush includes an axially extending annular flange that extends through the aperture in the housing. When assembled, the axially extending annular flange is beaded radially outward and over an inner surface of the housing adjacent the aperture to secure the bush in the aperture in the housing.

In one embodiment, the bush further includes a second axially extending cylindrical portion that is on an opposite side of the bush as the axially extending annular flange. The adjustment shaft includes a circular recess. The second axially extending cylindrical portion is radially inwardly beaded into the circular recess of the adjustment shaft to axially secure the adjustment shaft within the bush.

In one embodiment, an inner surface of the housing adjacent the aperture through which the adjustment shaft extends includes a plurality of recesses. The axially extending annular flange engages the recesses during the beading process.

In one embodiment, the thermostat further includes a driver operably attachable to the adjustment shaft. The driver is configured to be attached to the adjustment shaft in more than one angular orientation about the rotational axis of the adjustment shaft. The driver is configured to engage a knob and to translate rotation motion of the knob to the adjustment shaft.

In one embodiment, a method of assembly a thermostat is provided. The method includes attaching a U-shaped cover to an L-shaped main body to form a housing; securing an adjustment shaft to the housing for rotation; attaching a temperature sensor assembly to the housing; attaching, operably, a switching arrangement to the housing and the temperature sensor assembly such that the temperature sensor assembly actuates the switching arrangement in response to sensed changes in temperature; and connecting the switching arrangement to the adjustment shaft in such a manner that rotation of the adjustment shaft adjusts the temperature at which the temperature sensor assembly actuates the switching arrangement.

In one embodiment, the adjustment shaft includes a recess bound by a radially inward directed cam surface. The cam surface has a varying radius relative to a rotational axis of the adjustment shaft. The switching arrangement includes a cam follower. The step of connecting the switching arrangement to the adjustment shaft includes inserting the cam follower into the recess and biasing the cam follower into contact with the cam surface such that rotation of the adjustment shaft adjust the position of the cam follower as well as a temperature setting of the thermostat.

In one embodiment, the U-shaped cover includes a first side portion, a second side portion and a base portion. The first and second side portions are operably coupled to one another by the base portion to form the U-shape with an opening formed between the first and second side portions. The L-shaped main body includes a bellows plate portion and a first leg portion that extends at an angle relative to the bellows plate portion. When assembled, the housing defines a generally open side that is opposite the side provided by the bellows plate portion. The first and second side portions extend outward from the base portion and define free distal edges. Each of the first and second side portions includes at least one connecting tab extending from a first edge that extends between the free distal edge and the base portion of the corresponding side portion. The bellows plate portion includes a corresponding aperture configured to receive a corresponding one of the connecting tabs therethrough. The step of attaching a U-shaped cover to an L-shaped main body to form a housing includes inserting the connecting tabs into the apertures formed in the bellows plate portion; plastically bending the connecting tabs inward and over an outer surface of the bellows plate portion to secure the main body to the cover, with the first leg portion of the main body being positioned adjacent the free distal edges of the first and second side portions. A free distal edge of the bellows plate portion is positioned adjacent the base portion.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective view of an embodiment of a thermostat constructed in accordance with the present invention;

FIG. 2 is an exploded view of the thermostat of FIG. 1;

FIG. 3 is a cross-sectional view of the thermostat of FIG. 1;

FIG. 4 is a perspective illustration of an embodiment of a cover of the thermostat of FIG. 1;

FIG. 5 is an alternative embodiment of a cover for use in a thermostat as well as an alternative adjustment shaft arrangement;

FIG. 6 illustrates the interior surfaces of the cover of FIG. 5;

FIG. 7 is a perspective illustration of the main body of the thermostat of FIG. 1;

FIG. 8 is a perspective illustration of a bellows lever of the thermostat of FIG. 1;

FIG. 9 is a cross-sectional illustration of the main body of FIG. 7;

FIG. 10 is a perspective illustration of a lever of the thermostat of FIG. 1;

FIG. 11 is an exploded illustration of a snap acting blade forming part of the switching arrangement of the thermostat of FIG. 1;

FIG. 12 is a cross-sectional illustration of an alternative embodiment of a portion of a switching arrangement of a thermostat that includes a warning function.

FIG. 13 is a perspective view of an alternative embodiment of a cover;

FIG. 14 is a perspective illustration of a portion of the switching arrangement of the embodiment of FIG. 12;

FIG. 15 illustrates a further embodiment of a contact blade that can be used in a thermostat according to the present invention;

FIGS. 16 and 17 illustrate a further portion of an embodiment that includes a barrier to seal the contact arrangement that makes and breaks a circuit from the temperature sensor assembly;

FIGS. 18 and 19 illustrate a further embodiment that includes an auxiliary actuator structure;

FIG. 20 illustrates an alternative embodiment that includes a resistor in parallel with the contact arrangement;

FIGS. 21 and 22 are perspective illustrations of the adjustment shaft of the thermostat of FIG. 1;

FIGS. 23-25 illustrate a further embodiment of an adjustment shaft for use in a thermostat that utilizes a driver;

FIG. 26 illustrates a clip that can be used to secure an adjustment shaft to the housing of a thermostat;

FIGS. 27 and 28 illustrate a further alternative arrangement of an adjustment shaft and driver;

FIG. 29 is a partial cross-sectional illustration of the cover and adjustment shaft of FIG. 5;

FIG. 30 is an exploded view of the bush and adjustment shaft of FIG. 5;

FIG. 31 is an exploded view of a further embodiment of a thermostat according to an embodiment of the present invention; and

FIG. 32 is a cross-sectional illustration of the thermostat of FIG. 31.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

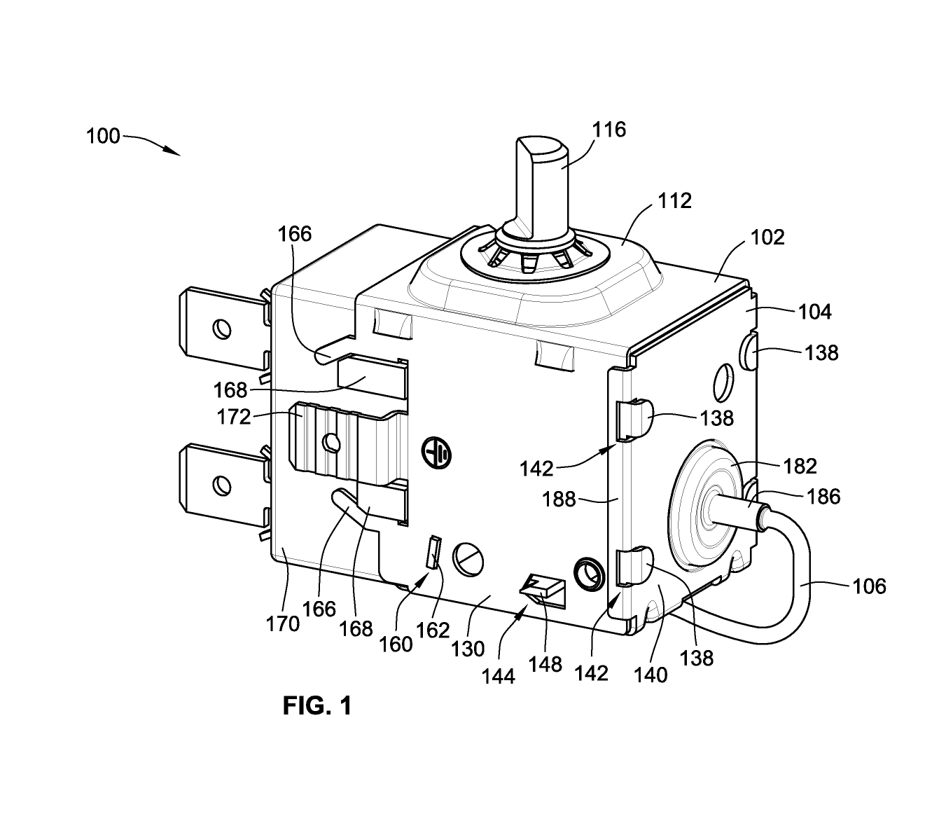

FIG. 1 illustrates a first embodiment of a thermostat 100 according to the teachings of the present invention. The thermostat 100 can be used in temperature controlled environments such as refrigerators and freezers. The thermostat 100 is a constant cut in type thermostat, wherein the cut in temperature is constant.

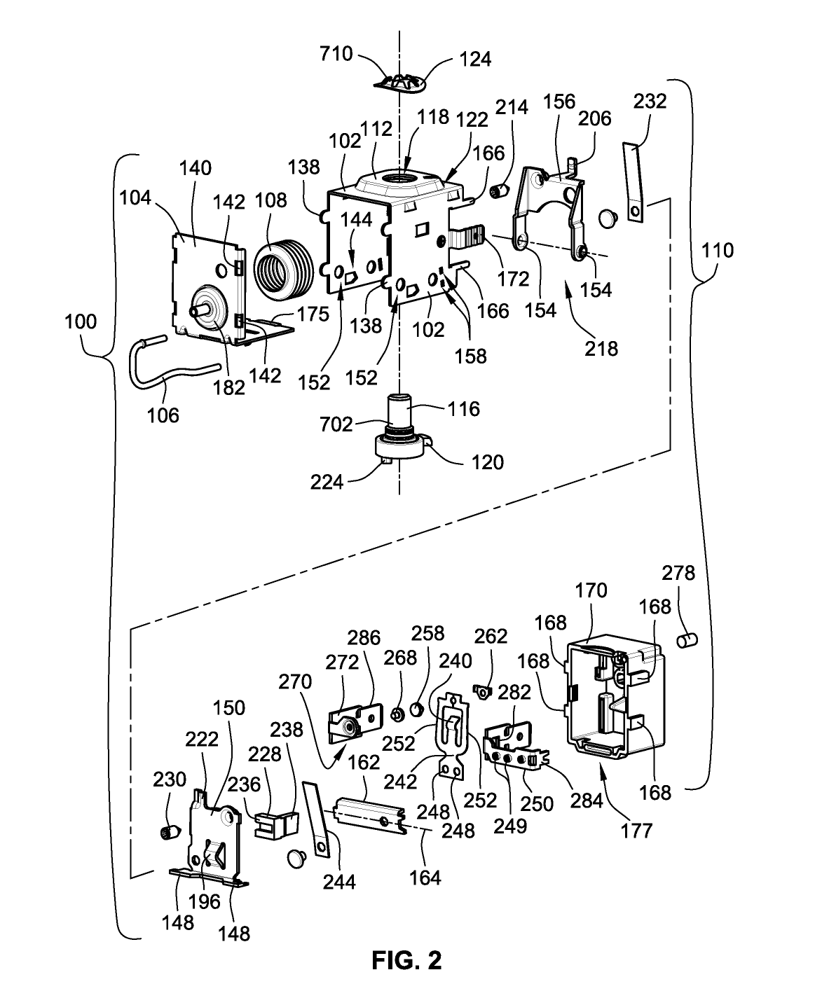

With additional reference to FIG. 2, the thermostat 100 includes a housing formed from a cover 102 and a main body 104. The thermostat 100 also includes a capillary 106 that extends into the temperature controlled environment that cooperates with an actuation member illustrated in the form of bellows 108 to operate a switching arrangement 110 as a result of changes in temperature in the controlled environment. More particularly, an operating fluid that expands and contracts due to changes in temperature is located within the capillary 106 and the bellows 108 that causes the bellows 108 to operably actuate the switching arrangement 110.

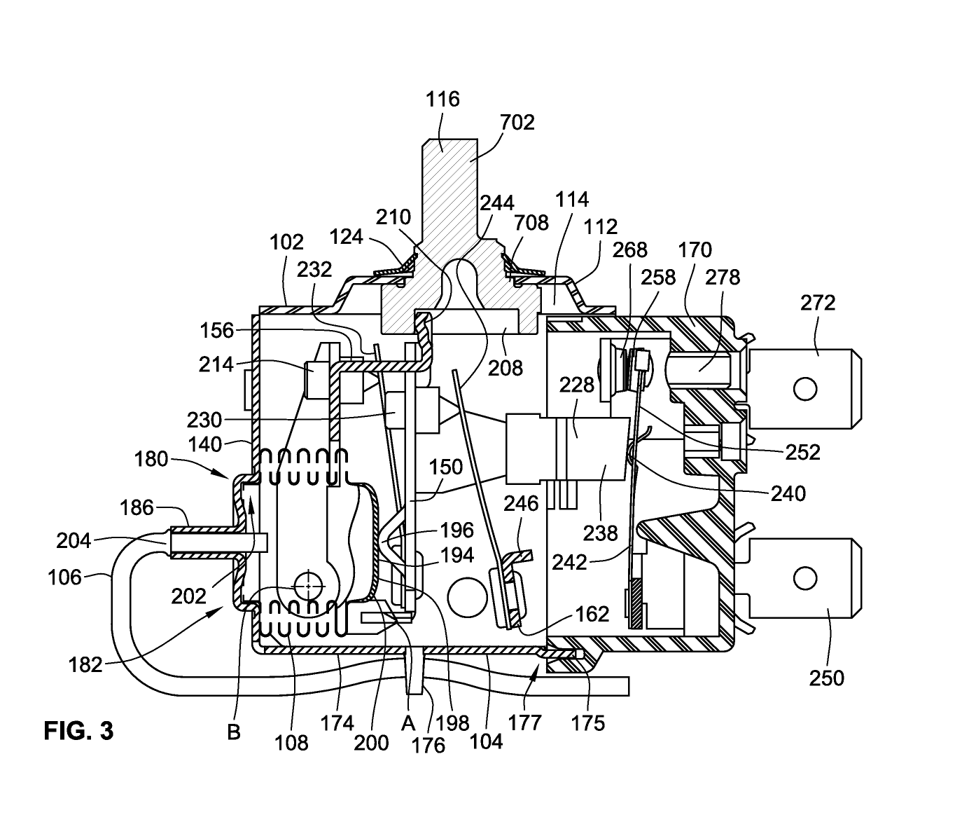

With reference to FIGS. 1-6, the cover 102 is a generally U-shaped component preferably formed from metal, which may or may not be coated with a finish to improve corrosion resistance. The cover has an outward extending embossed region 112, which is approximately square in shape with rounded corners. The embossed region 112 forms an outwardly recessed cavity 114 (see FIGS. 3 and 6).

An adjustment shaft 116 extends through an aperture 118 formed in the embossed region 112. The embossed region 112 includes an inward extending protection 122 that forms a stop. The adjustment shaft 116 includes a radially outward extending tab 120 that will contact the inward extending projection to limit the rotation of the adjustment shaft 116 relative to the cover 102. A retaining clip 124 engages the adjustment shaft 116 to secure the adjustment shaft 116 to the cover 102.

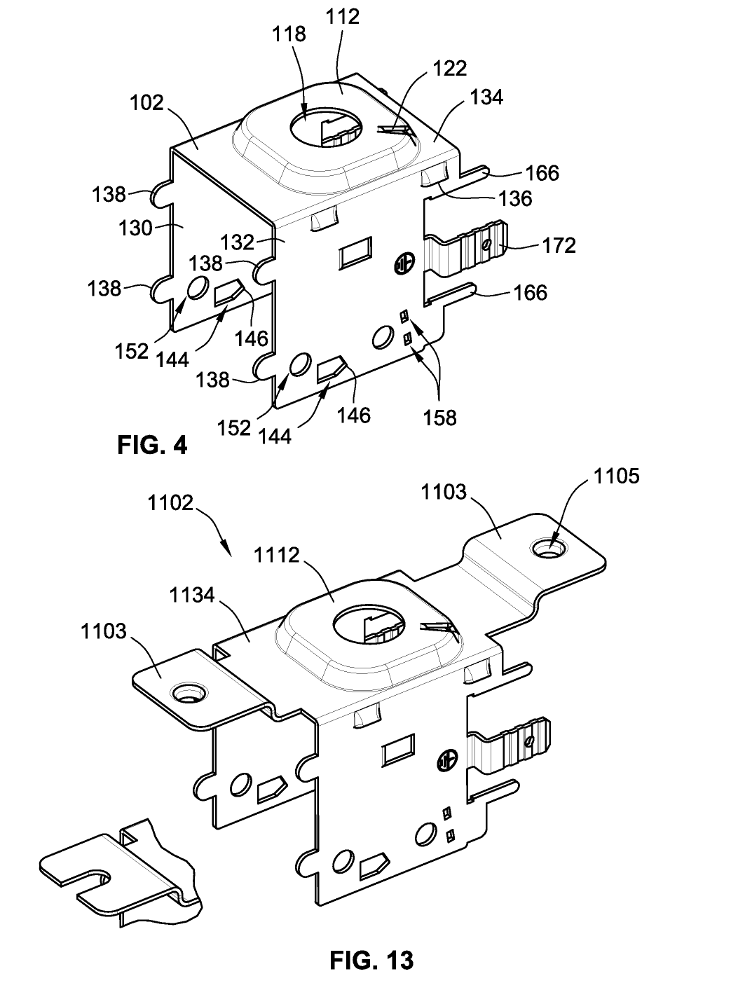

With primary reference to FIG. 4, the cover 102 generally includes a pair of sides 130, 132 (also referred to as “side portions”) that are connected by a base 134 that generally form a U-shape. The sides 130, 132 are laterally offset from one another and extend generally perpendicular to the base 134. The embossed region 112 is formed in base 134.

Each side 130, 132 includes a pair of outward stamped locating tabs 136 that are designed to be flexible coupling tabs for securing the cover 102 and the thermostat 100 to a panel of the appliance in which the thermostat 100 is installed. The tabs will allow for snap mounting of the cover 102 to the panel.

With reference to FIGS. 1, 2, 4 and 7, the cover 102 also includes four connecting tabs 138 for connecting the cover 102 to the main body 104, and particularly to the bellows plate portion 140 of the main body 104. The main body 104 includes corresponding tab receiving apertures 142 in the bellows plate portion 140 through which the connecting tabs 138 extend. The connecting tabs 138 are then folded over to secure the cover 102 to the main body 104.

The cover 102 includes two pentagonal shaped apertures 144, one in each side 130, 132. Each aperture 144 terminates in a corner 146. The pentagonal shaped apertures 144 receive corresponding pivot portions 148 of the bellows lever 150 (see e.g. FIGS. 1, 2 and 4). Two circular cut-outs 152 are provided, one in each side 130, 132. These cut-outs 152 receive pivot portions 154 of lever 156. The cover 102 also includes two rectangular cut-outs 158 in side 132 and a single, larger, rectangular cut-out 160 generally opposed to the rectangular cut-outs 158 for mounting spring blade support 162. These cut-outs 158, 160 cooperate with corresponding mounting portions, or tabs, of the spring blade support 162 and prevent rotation of the spring blade support 162 about a longitudinal axis 164 thereof that is generally perpendicular to sides 130, 132.

The cover 102 also includes, prior to assembly, four axially extending switch base connecting tabs 166 that extend from the opposite edges of sides 130, 132 as connecting tabs 138. Switch base connecting tabs 166 are bent during assembly of the thermostat 100 (see FIGS. 1 and 2) about connecting lugs 168 of the switch base 170 to secure the switch base 170 to the cover 102. Each side 130, 132 of the cover also includes two axially extending tabs 172 that are initially offset laterally outward from the sides 130, 132. These tabs 172 are ground terminals.

FIG. 13 illustrates a further embodiment of a cover 1102. This cover 1102 is similar to cover 102 but includes a pair of wings 1103 that extend from the base 1134 and away from the embossed region 1112. The wings 1103 include a hole 1105 that can be used for mounting the thermostat. Alternatively, the holes 1103 could be replaced with slots. Otherwise, cover 1102 is substantially similar to that as described previously.

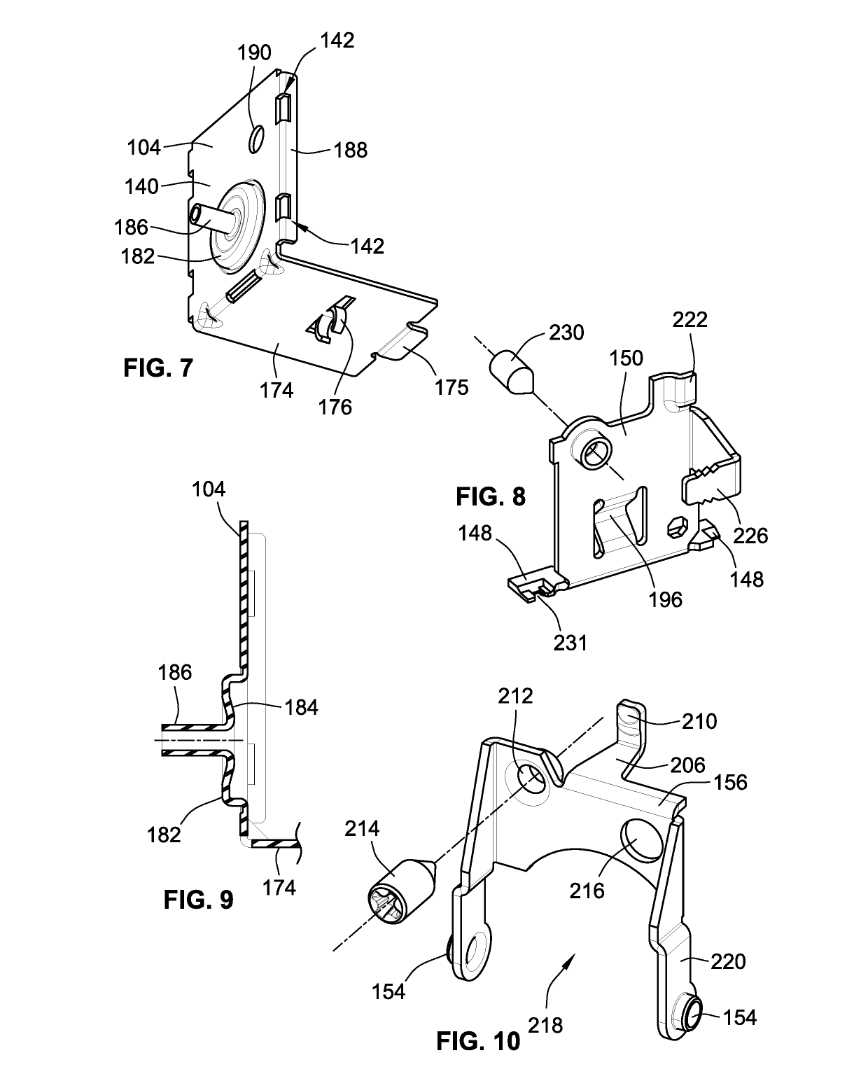

With primary reference to FIG. 7, the main body 104 is generally L-shaped including two primary leg portions. One of the leg portions is the bellows plate portion 140. The other leg portion 174 extends generally perpendicular from bellows plate portion 140. Leg portion 174 includes a pair of arcuate capillary connecting tabs 176 that extend outward from leg portion 174. The capillary connecting tabs 176 are curved toward one another and are used to secure the capillary 106 to the main body 104 (see e.g. FIG. 3). In one embodiment, the bending radius of the capillary connecting tabs 176 is at a minimum of 3.0 mm. Leg portion 174 also includes a connecting extension 175 that fits into a slot 177 formed in the switch base 170 to assist in assembly of the components.

A sensor assembly 180 (see FIG. 3), which includes the bellows plate portion 140, the bellows 108, and capillary 106 (also referred to as a capillary tube). The bellows 108 is preferably soldered to bellows plate portion 140. The main body 104, and particularly the bellows plate portion 140, is preferably a piece made of a metallic alloy.

With reference to FIGS. 7 and 9, the bellows plate portion 140 includes a circular stamping 182 that generally extends outward from the bellows plate portion 140 and which serves to accommodate and position the bellows 108 in its correct place during assembly. The stamping includes a circular inclined area 184 which serves as a barrier for the solder to reach the inner surface of capillary tube receiving tube 186 while soldering the bellows 108 to the bellows plate portion 140. Additionally, in the circular stamping 182 is the capillary tube receiving tube 186 which enables passage of the capillary tube 106 toward the interior of the bellows 108 of the thermostat 100.

The bellows plate portion 140 also includes bent reinforcement flaps 188. The bent reinforcement flaps 188 are spaced laterally from one another a distance substantially equal to the width of between outer surfaces of the side portions 130, 132 of the cover 102 such that the side portions 130, 132 will mount in between the reinforcement flaps 188 when the thermostat is fully assembled. The reinforcement flaps 188 will substantially overlap the outer surface of the adjacent one of the side portions 130, 132 when assembled. The reinforcement flaps 188 are bent at approximately a ninety degree angle relative to the bellows plate portion 140. The apertures 142 formed in the bellows plate portion 140 for receiving the connecting tabs 138 of the cover 102 being formed in the bend between the main portion of the bellows plate portion 140 and the bent reinforcement flaps 188.

The bellows plate portion 140 also includes an aperture for receipt of a tool to access an adjustment screw for setting the thermostat 100.

The bellows 108 is formed from a flexible and ductile metallic material. With primary reference to FIG. 3, the bellows 108 has a closed end 194 with a thickness greater than that of a convoluted region that expands and contracts due to changes in the pressure of the working fluid within the capillary 106 and interior of the bellows 108. The thickened closed end 194 provides sufficient mechanical strength to withstand the stress caused by contact with the stamped region 196 of the bellows lever 150. The variation in the thickness of the bellows 108 occurs gradually, between the flat region 198 of greater thickness and adjacent cylindrical region 200 of reduced thickness.

The opposite end of the bellows 108 is an open end 202. The open end 202 is designed to mate with and against the circular stamping 182 of the bellows plate 140. The open end 202 is typically joined to the bellows plate 140 with a ring of solder, or glue, not shown. The solder or glue joins the capillary tube 106 to the bellows plate 140 and bellows 108 to couple the three components in a sealed configuration to seal the working fluid within the cavity formed by these components. Typically, the working fluid is a refrigerant, tetrafluorethane type, known as R134A, propane, known as R290, propylene, known as R1270, or any other fluid that has a temperature v. pressure relationship appropriate for the temperature range of operation of the thermostat 100.

The capillary tube 106 is preferably made of metallic material with good thermal conductivity such as copper, aluminum, or copper clad aluminum (CCA). An open end of the capillary tube 106 is axially received in the capillary tube receiving tube 186 of the circular stamping 182. The capillary tube 106 includes a cylindrical collar 204 that serves as a stop to limit the axial insertion of the capillary tube 106. After assembly a retaining collar, not shown, may be attached to the end of the capillary tube that is on the inside of the bellows plate 140 to further prevent removal of the capillary tube 106 from the bellows plate 140. The opposite end of the capillary 106 is sealed after filled with the working fluid.

With reference to FIGS. 2, 3 and 10, lever 156 is preferably a stamped metal. However, lever 156 could be made of engineering plastic, such as polycarbonate type, by adding one or more structural reinforcements. Lever 156 includes an L-shaped protruding tab 206 that is a cam follower that cooperates with an inner variable radius cam surface 208 of the adjustment shaft 116. Protruding tab 206 has a curved portion 210 to allow for improved contact with the inner cam surface 208. The curved portion 210 is formed by stamping and located in the upward bended portion of the L-shaped protruding tab 206. Rotation of the adjustment shaft 116 relative to cover 102 about a rotational axis of the adjustment shaft causes changes in the position of the protruding tab 206 (i.e. cam follower) to adjust a temperature set point of the thermostat 100 due to the varying radius configuration of the cam surface (see e.g. FIG. 22).

The lever 156 includes a threaded hole 212 that receives adjustment screw 214. The lever 156 also includes a clearance hole 216 that allows for adjustment of a further adjustment screw within the thermostat. The lever 156 defines a cutout region 218 to allow passage of the bellows 108. The lever 156 includes two side leg portions 220 with two extruded pivot portions 154 that fit into cut-outs 152 of the sides 130, 132 of the cover 102 (see e.g. FIG. 4).

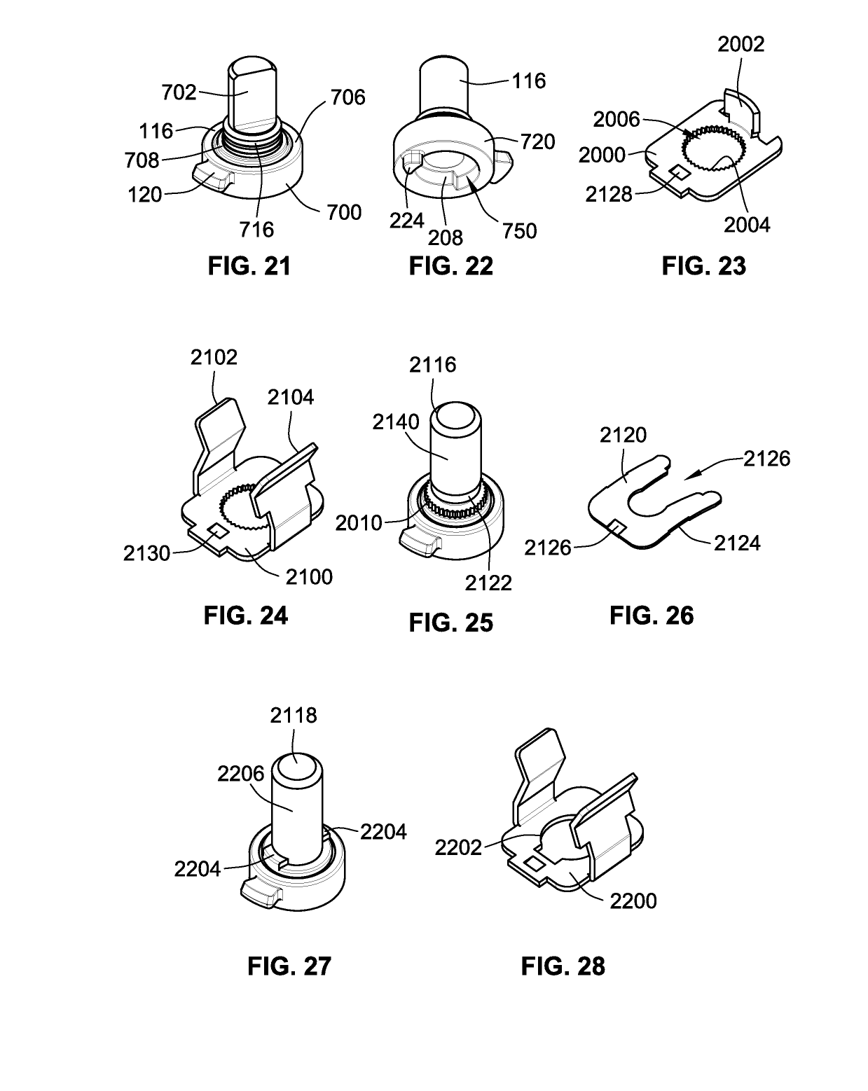

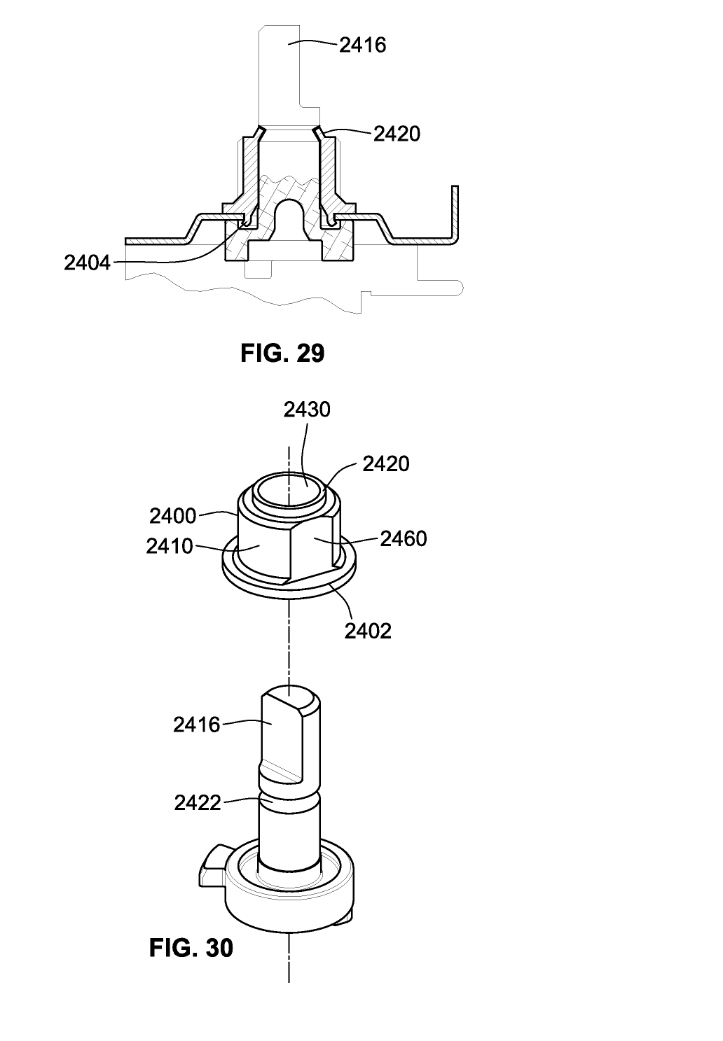

With reference to FIGS. 2, 3 and 21, the adjustment shaft 116 is a component made of plastic or metal and has a roughly cylindrical portion 700, and a second portion 702 with a flat for engaging a knob (not shown). The second portion 702 passes through the aperture 118 of the cover 102 and surface 706 abuts the inner surface of the cover 102. The adjustment shaft 116 has a cylindrical region 708 designed to fit perfectly into the aperture 118 of the cover 102, and is held in place against said inner surface of the cover 102 by the action of the retaining clip 124.

The retaining clip 124 is made of flexible metal material and has cut out tabs 710 disposed on its inner surface and with a proper slope so that it fits into a circular recess 712 made in the adjustment shaft 116. The cylindrical portion 700 includes tab 120 designed to serve as a stop against turning when it engages inward extending projection 122 of the cover 102 as discussed above. The cylindrical portion also has a recess 750 that is bounded by variable radiused inner cam surface 208 that functions as a cam that cooperates with the tab 206 of lever 156. Here, the tab 206 of lever 156 is received axially into recess 750 of the adjustment shaft 116. Spring blade 232, discussed more fully below, biases lever 156, and particularly tab 206 against inner cam surface 208. Angular adjustment of the adjustment shaft 116 by rotation about its axis of rotation adjusts the position of lever 156 by rotating lever 156 about pivot portions 154.

A tongue 224 projecting axially from the cylindrical portion 700 configured to push a stamped region 222 of bellows lever 150 when the adjustment shaft 116 rotates in a given direction of rotation until abutting the stop 122 provided by cover 102.

The configuration described above for the adjustment shaft 116 is preferred because it has fewer components and is easier to assemble in the thermostat 100, resulting in a lower project cost, but may also have other configurations.

FIGS. 23-26 illustrate an alternative configuration of the adjustment shaft 2116 which engages a driver. FIG. 23 illustrates a first driver 2000 that has one flap 2002. The first driver 2000 is preferably made of metal material and consists of an essentially flat portion 2004 that has a hole 2006 which has a toothed inner periphery that engages and mates with a corresponding toothed region 2010 of adjustment shaft 2116. This toothed system of these components, driver 2000 and adjustment shaft 2116, enables the fitting of the driver 2000 at different angular positions with respect to the adjustment shaft 2116. A second driver 2100 is illustrated in FIG. 24 and has a pair of flaps 2102, 2104 for engaging with a knob.

In FIG. 26, a clip 2120 is made of metal material with flexibility to fit into a circular groove 2122 made in the adjustment shaft 2116. The clip 2120 includes a bend 2124 to press the driver 2000 or 2100 against the outer surface of the stamped region 112 of the cover 102 and the cylindrical portion of shat 2116 against the inner surface of cover 102. Said clamp 2120 has an opening 2126 to enable engagement of the clip 2120 into the circular recess 2122 in the adjustment shaft 2116. The clip 2120 can include a stamped recess 2126 configured to mate with a corresponding stamp 2128, 2130 of the driver 2000, 2100 to avoid any movement between these two parts and to prevent removal of the clip 2120 from the recess 2122.

In FIG. 23, driver 2000 includes tab 2002 that may be flat or shaped with a radius of curvature, which is intended to receive the knob through a recess made therein. The spinning of the adjustment shaft 2116 is obtained due to the tight fit of the mating toothed regions of the driver 2000, 2100 and the adjustment shaft 2116. The adjustment shaft 2116 also has a cylindrical region 2140 intended to serve as a guide and to fix said knob.

FIGS. 27 and 28 illustrate another version of a driver 2200 and adjustment shaft 2118. The driver 2200 includes two cut outs 2202 located approximately opposite one another. In this embodiment, the adjustment shaft 2118 includes a pair of radially extending protrusions 2204 formed outward from cylindrical region 2206 that are arranged in the same way as the two cutouts 2202 in the hole made in the driver 2200 which allow the two components to engage and transfer rotation motion therebetween.

These additional adjustment shafts 2116, 2118 would have the same features for engagement with the switching arrangement of the thermostat.

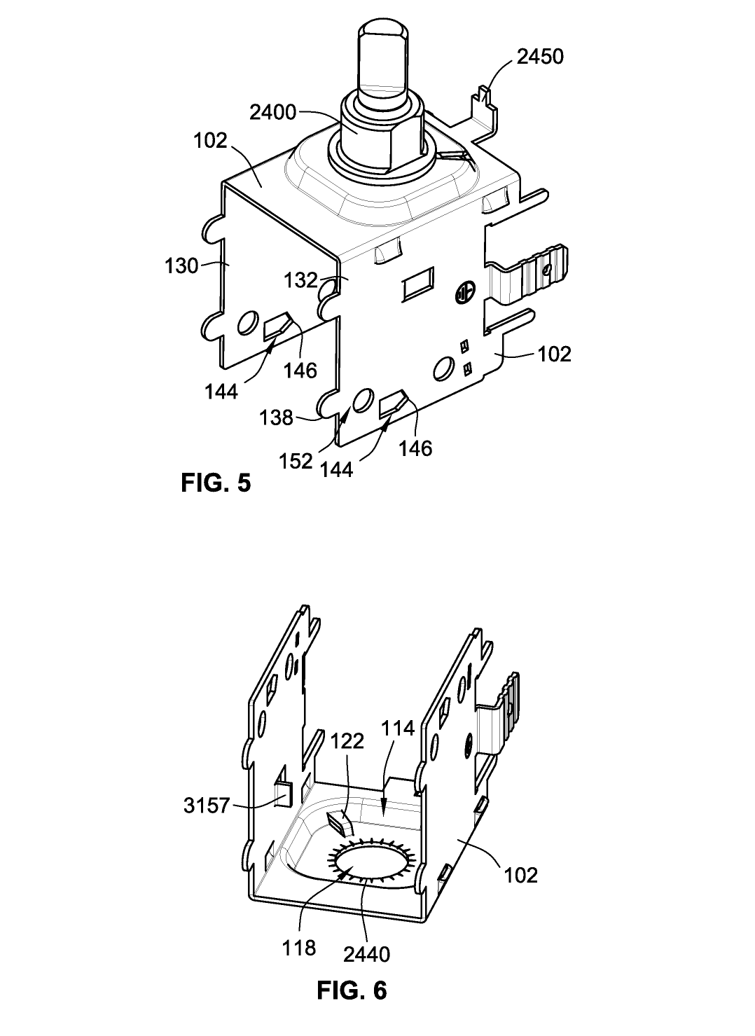

FIG. 5 illustrates an alternative embodiment for mounting the thermostat to appliance. This embodiment uses a central bush. This embodiment uses a central bush 2400 preferably made of metallic material, composed of several cylindrical parts including a larger diameter flange 2402 configured to abut the outer surface of the embossed region 112 of the cover 102, an axially extending annular flange 2404 designed to pass through the aperture 118 of cover 102 and to be beaded radially outward to secure the central bush 2400 to the cover 102 (see FIG. 30). The bush 2400 includes another cylindrical region 2410 which is threaded and functions as a nut for fixing the thermostat to the appliance.

The central bush 2400 includes a second axially extending cylindrical portion 2420, located on top of cylindrical portion 2410 which is beaded into a circular recess 2422 of the shaft 2416 which serves to secure the adjustment shaft 2416.

Bush 2400 includes a central hole 2430 to allow passage of adjustment shaft 2416. To help in fixing the bush 2400 to the cover 102, small recesses 2440 (see FIG. 6) along the periphery of the aperture 118 of the cover 102 can also be provided. The beading of the axially extending annular flange 2404 penetrates the spaced provided by recesses 2440, resulting in greater resistance to torque between the bush 2400 and cover 102.

If necessary, a mechanism to avoid turning the thermostat with respect to the appliance panel where it will be installed may be provided. This mechanism can be done through a tongue 2450 made in an extension of the cover 102 (see FIG. 5), which must fit into a hole made on the appliance panel. Alternatively, flats 2460 formed in the threaded region 2410 of the central bush 2400 could be provided. The opening in the appliance panel would include cooperating flats to prevent rotation.

With reference to FIGS. 2, 3, and 8, the bellows lever 150 is preferably formed from a stamped sheet metal. The bellows lever 150 preferably includes a flap 222 formed with a characteristic is be pressed against a tongue 224 of the adjustment shaft 116 when the adjustment shaft 116 is rotated. As noted above, the bellows lever 150 includes a stamped region 196 that is pressed against the thickened closed end 194 of the bellows 108. A bent tab 226 extending opposite the stamped region 196 receives a plastic L-shaped actuator 228. The bent tab 226 is toothed on the edges to improve engagement with the actuator 228. The bellows lever 150 includes a drawn threaded hole for receiving a further adjustment screw 230. As noted above, the bellows lever 150 further includes pivot portions 148 that are formed by a flange that is bent relative to the main body portion of the bellows lever 150. One of the pivot portions 148 is clipped to form a groove 231 which receives a portion of one of the sides 130, 132 near the pivot corner 146 to position and limit lateral movement of the bellows lever 150 when mounted to the cover 102.

A spring blade 232 is riveted to the bellows lever 150. The spring blade 232 is formed from a metallic material with a spring characteristic, i.e. hardness and mechanical strength appropriate to have a flexibility when a force is applied near its end. The thickness can vary to achieve a distinctive spring rate in order to achieve different ranges of operating temperature for the thermostat. The spring blade 232 cooperates with the adjustment screw 214 that is carried by lever 156.

The L-shaped actuator 228 is formed from a plastic material that has high mechanical strength and good electrical insulation, such as polyacetal. The Actuator 228 includes a first portion 236 that receives tab 226 and a second portion 238 that extend generally perpendicular to that first portion that touches a tab 240 of blade 242.

With reference to FIG. 3, a second spring blade 244 is riveted to spring blade support 162. The second spring blade 244 is similar to spring blade 232. A distal end of the second spring blade 244 contacts adjustment screw 230 which is carried by the bellows lever 150. The spring blade support 162 may include a bent flange 246 to increase its structural rigidity (see e.g. FIG. 3).

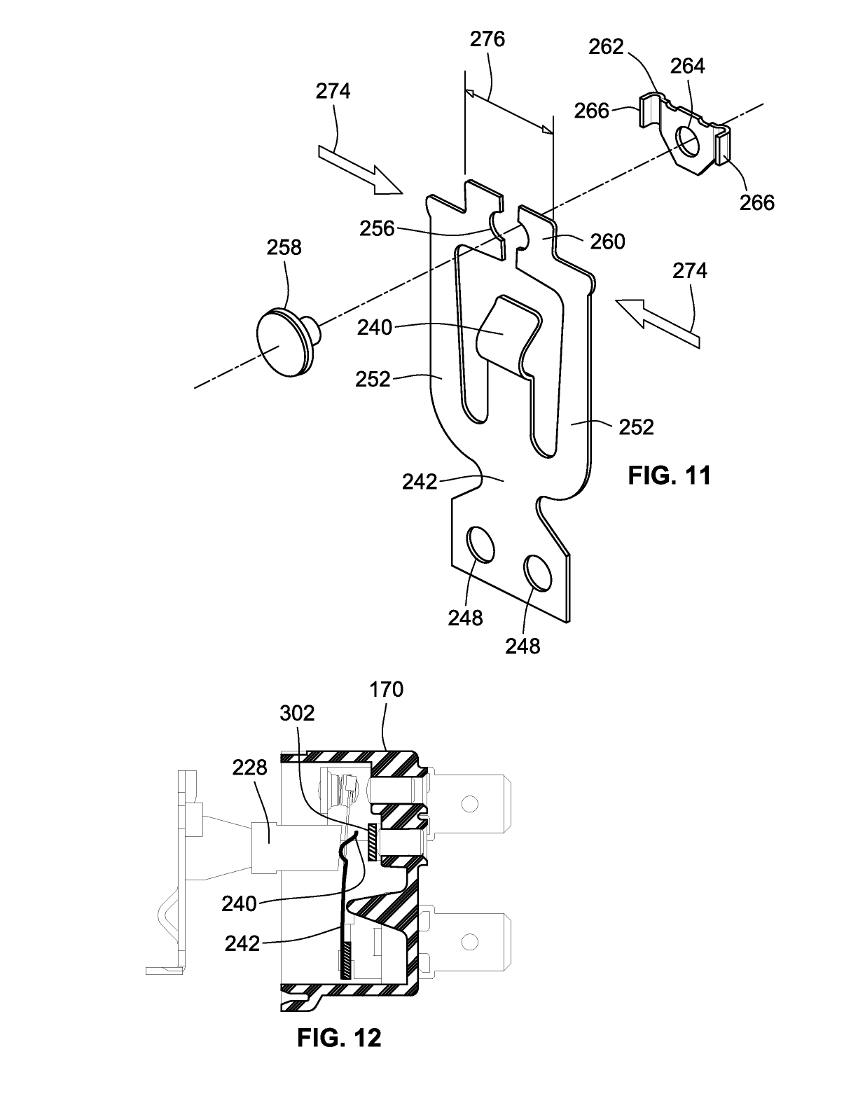

Blade 242 is made of a metallic material of good electrical conductivity and also of good mechanical strength, such as a phosphor bronze, beryllium copper or the like. The blade 242 is preferably flat and is generally shaped like a letter Q. With reference to FIG. 2, the blade 242 includes a flap on one end containing two holes 248, see FIG. 11, designed to fit into two cylindrical bosses 249 of the terminal 250. This blade 242 has in its central region an aforementioned tab 240 containing a curved stamped region with the purpose of contacting a distal end surface the actuator 228. The blade 242 also has two side arms 252 which extend to its other end. The two arms 252 approach one another and maintain a gap therebetween. These two side arms 252 can have constant width or can reduce in width when moving away from the flap that includes holes 248. The free distal ends of the side arms 252 each include a semi-circular cutout 256 for receiving a contact 258. These end near the gap inclined at an angle of approximately 3 degrees on each end. This tilt allows the subsequent pre-stressing of the side arms 252, which can be performed before or after mounting the blade 242 to terminal 250. The free end of blade 242 opposite the end with holes 248 also defines a boss 260 for mounting a bridge 262. The side arms 252 taper at an angle when moving towards the distal free ends that include the cutouts 256. The angle is preferably between about 4 to 10 degrees and preferably 7 degrees resulting in a progressive increase in material in the side arms 252 when moving from the distal free ends towards their connected ends proximate central tab 240.

The electrical contact 258 is made of a good electrical conductor, such as silver or silver alloy, and has a cylindrical shape with its contact surface slightly spherical. The contact 258 includes a reduced diameter shank configured to fit through the semi-circular cutouts 256 of the blade 242 and hole 264 of the bridge 262 for attachment. The bridge 262 is made of good electrical conductor material, preferably a copper alloy such as brass or phosphor bronze, and has two side wings 266 to engage the boss 260 of the blade 242. It also has the aforementioned hole 264 for receiving the cylindrical region of the contact 258 for attachment. An alternative blade 242′ is illustrated in FIG. 15.

With reference to FIG. 2, a second electrical contact 268 is provided that is similar to electrical contact 258 and is made of the same material. The second electrical contact 268 has a shank having a smaller diameter to fit into a hole 270 of a second terminal 272. The two contacts 258, 268 cooperate with one another to open or close the primary circuit of the thermostat to either provide or cut power to a compressor, as will be more fully described.

The process of fixing the contact 258 and bridge 262 on the blade 242 occurs as follows. It is necessary to apply a force on the blade 240 in the direction indicated by arrows 274 (see FIG. 11) to obtain the reduction of dimension 276 of the boss 260 in sufficient quantity so that the bridge 262 can receive boss 260 to reduce and/or eliminate the gap between the distal ends of the side arms 252. The side wings 266 of the bridge 262 hold the distal ends of the side arms 252 pressed against one another. The result of this type of construction is that the side arms 252 of the blade 242 are “sheeted” to the opposite side of the stamped region of the tab 240. The riveting of the contact 258 is such as to allow a slight movement of the side arms 252 in the same direction as the actuating of the central tab 240 of blade 242.

The motion of the distal ends of the side arms 252 including the attached contact 258 and bridge 262 is limited by adjustment screw 278 (see e.g. FIG. 3). Actuation of central tab 240 by actuator 228 will cause the side arms 252 of blade 242 to move from their resting position to another position in instantaneous movement, in a “click.” This movement is used to obtain an electrical connection between contacts 258, 268.

With reference to FIG. 2, terminal 250 is preferably made of a copper alloy like brass, with good electrical conductivity. Terminal 250 includes an extension 280 that extends to the outside of the switch base 170 and that is intended to connect to the grid of the appliance where the thermostat 100 is used. Terminal 250 has a tongue 282 that extends into a corresponding groove or recess formed in the switch base 170. At its other end, terminal 250 has a tab 284 designed to fit in another opening of switch base 170 for fixing the terminal 250 to the switch base 170.

Terminal 272 is also preferably made of a copper alloy like brass, with good electrical conductivity. Terminal 272 includes an extension 286 that extends to the outside of the switch base 170 and is designed to connect to the grid of the appliance where the thermostat 100 is used. While not shown, this terminal 272 has a tongue similar to tongue 282 of the prior terminal 250 to mount the terminal 272 to the switch base 170. Terminal 272 has a hole 270 for receiving contact 268.

Terminals 250 and 272 can also have their extensions 280 and 286 positioned at the other end thereof.

The switch base 170 is made of plastic material of high mechanical strength and good electrical insulation, preferably of the type polyamide (nylon) or polyester, but not limited to these and may have mineral or fiberglass load to improve the appropriate properties. The switch base 170 has the shape of a box with one side open to interact with other parts of the thermostat 100. As noted above, the switch base 170 also has four (4) connecting lugs 168 that are generally rectangular or square with two located on each side that cooperate with the switch base connecting tabs 166 of the cover 102 by staking. The switch base 170 also a plurality of rectangular configured to receive the extensions 280, 286 of the terminals 250, 272. The switch base 170 may also include side ribs (not shown), which also have the function of separating the terminals to obtaining an electrical safe distance between the terminals.

The above description is for the basic version of the thermostat of the present invention.

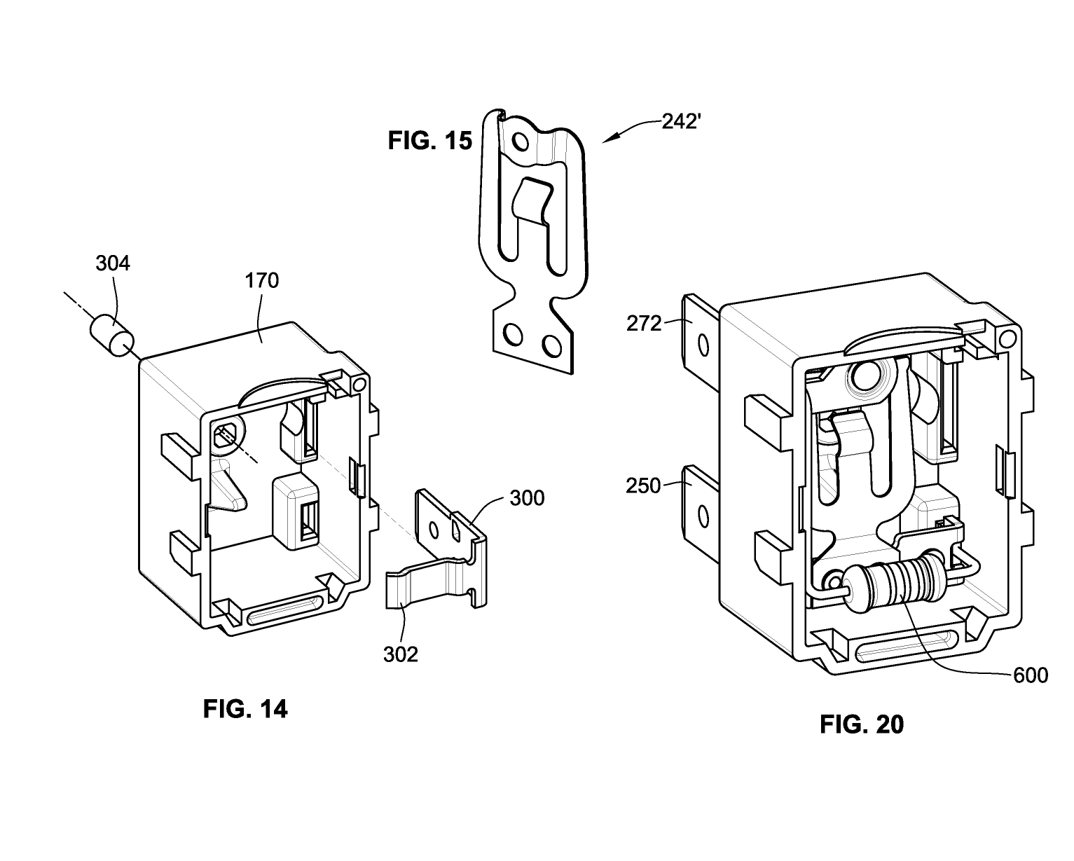

With reference to FIGS. 12 and 14, an extra terminal 300 may be provided that provides for an alarm function. When there is a risk of being lost, or there is a deterioration of the product that is in the environment to be controlled, such as the load of a freezer, it is desirable to have a system that knows when the temperature exceeds a certain preset value, warmer than normal initiation temperature of the thermostat, but not enough to initiate the deterioration of the controlled content. This is achieved through the use of an alarm terminal 300, L-shaped piece of good electrical conductor material, preferably copper alloy such as brass, which extends to the outside of switch base 170 and that is configured for connection to the grid of the appliance where the thermostat is used. At the other end of this auxiliary terminal has a tab 302 designed to receive the contact of the central tab 240 of the blade 242. A screw 304 can be mounted in a hole of switch base 170 to regulate the position of the tab 302 of the terminal 300.

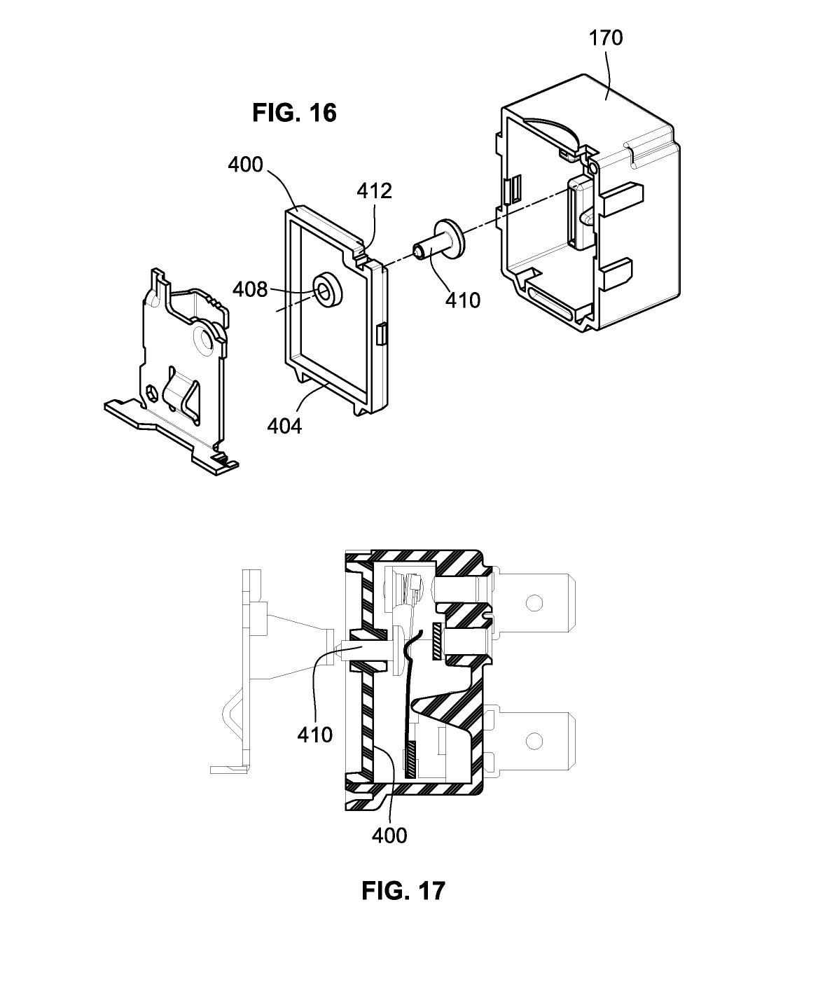

With reference to FIGS. 16 and 17, another version of a thermostat includes a seal for the switch in order to prevent a possible electrical arc formed during the electrical switching of contacts can cause an explosion due to the presence of a flammable gas. There is a tendency to use isobutane gas, commonly called R600a, as load of the refrigeration system of refrigerators. This gas is flammable and can explode when a certain concentration and the presence of a spark as an arc.

To prevent this from happening, this embodiment provides a barrier 400. Barrier 400 is mainly composed of an insulator preferably made of electrical insulation material, and is essentially a flat plate and may contain a reinforcement flange 404 along its periphery to obtain good mechanical strength. The barrier 400 may include a hole 408 in its central region for passage guidance of actuator 410. This barrier 400 may also have a tear 412 in one of its corners to enable the passage of one component from another version and also serves to prevent the assembly of this component in the switch base in another position, beyond the normal. This barrier 400 fits perfectly, without gaps, within the switch base 170 (see FIG. 17).

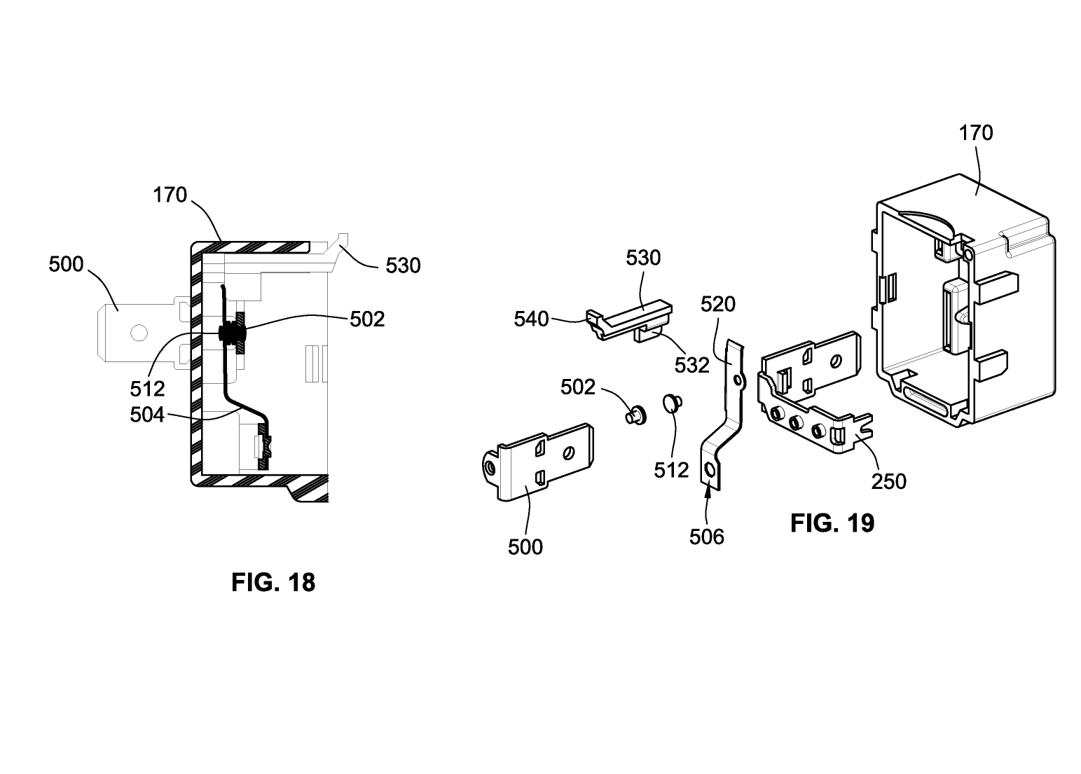

FIGS. 18 and 19 illustrate another version of the thermostat, which provides an extra terminal 500 for an auxiliary switch. This version is composed, in addition to the components of the standard version described above, an auxiliary terminal 500 made of a good electrical conductor, preferably a copper alloy such as brass, having an extension to the outer side of the switch base 170 and which serves for the electrical connection to the appliance.

Terminal 500 has one end forming an angle of approximately 90 degrees with the portion extending out of the switch base 170. This angled portion caries an auxiliary contact 502. An auxiliary blade 504 is made of a material with good electrical conductor and good flexibility to act as a spring, as is the case of phosphor bronze or beryllium copper. It has in one of its ends a hole 506 designed to be secured by staking to the terminal 250.

The other end of auxiliary blade 504 carries a second auxiliary contact 512. The middle of the blade 504 can include bends to make it more flexible and to adapt to the relative position between the portion of the terminal 250 where the auxiliary blade 504 is attached and the location of the auxiliary contact 502 carried by terminal 500. This auxiliary blade 506 may also have a bended area 520 to make the area where the second auxiliary contact 512 is attached more rigid.

This version includes an auxiliary actuator 530 designed to fit in the tear 412 discussed in the prior embodiment. The actuator 530 slides in tear 412. The actuator 530 also has an extension 532 which is configured to reach the blade 504 and to separate contacts 502, 512, resulting in the opening of the auxiliary switch. Displacement of the actuator 530 is provided by the tab 120 of the adjustment shaft 116 (illustrated in FIG. 2) when the adjustment shaft 116 is rotated until its stop against the inward extending projection 122 of cover 102, preferably in a counterclockwise direction. The corner of tab 120 of the adjustment shaft 116 touches the surface 540 of actuator 530, causing it to bend the auxiliary blade 504 in order to separate the contacts 502, 512.

FIG. 20 illustrates another embodiment of the thermostat that includes a resistor 600 coupled internally to the electrical switch, and particularly to terminals 250 and 272, thus being in parallel with the main switch of the thermostat. This resistor 600 has an Ohmic resistance that can vary from 33 kOhm to 120 kOhm, preferably about 82 kOhm.

With reference to FIG. 3, the operation of the thermostat 100 will now be described. The bellows lever 150 pivots on pivot portions 148 relative to corner 146 of the cover 102 which defines pivot point A. Lever 156 has its pivot point B about which it can pivot. Support 162 is fixed relative to cover 102 where blade 244 is fixed.

Tab 240 of blade 242, when pressed by the actuator 228 to the right, i.e. away from bellows 108, causes, when blade 242 reaches the trigger point, the distal ends of side arms 252 carrying contact 258 to snap to the left. This action closes the circuit by causing contact 258 to engage contact 268. This is the situation represented in FIG. 3.

The end not shown of the capillary tube 106 is located at the point of temperature control. So a temperature variation in the control point will change the pressure of the control fluid (i.e. a gas) contained within the capillary tube 106 and bellows 108, following the curve of temperature versus pressure corresponding to the gas used. When forces are balanced due to the bellows 108 and blade 244 for a desired temperature, the bellows lever 150 will be in an intermediate position. When the gas pressure decreases (lower point temperature control) the bellows 108 will decrease its pressure on the tab 196 of the bellows lever 150. The force of blade 244 will then act on screw 230 causing the bellows lever 150 to rotate in a counterclockwise direction about pivot point A. This shift will occur until tab 240 of the contact blade 242 goes beyond its tipping point and then the firing of the side arms 252 of the blade 242 happens in the opening direction to disconnect the contacts 258, 268. In the FIG. 3, this causes contact 258 to be driven toward the right of the figure.

Adjustment screw 214 is adjusted so that its tip touches blade 232 before the snap action of the contact blade 242 occurs. The opening of the contacts 258, 268 causes the shutdown of the cooling system compressor, causing the temperature of the controlled environment to increase. When the temperature of the working fluid increases, the bellows 108 will press with increased force against tab 196 of bellows lever 150, causing it to move in a clockwise direction.

Because of this clockwise movement of the bellows lever 150, the blade 232 will do the same movement, because it is attached to said bellows lever 150. The screw 214 is adjusted so that the blade 232 will no longer be in contact with the screw 214 before the snap action phenomenon of the contact blade 242 occurs. The gas pressure of the working fluid continues to increase until the moment when the tab 240 of the contact blade 242 exceeds its equilibrium point and the side arms 252 of the contact blade 242 perform a snap action to the left of FIG. 3 so as to cause the contacts 258, 268 to contact closing the circuit placing the compressor in operation and restarting the refrigeration cycle.

The above explanation occurs for a given angular position of the adjustment shaft 116. When the shaft 116 is rotated to another position, the varying radius of the inner cam surface 208 changes the angular position of the lever 156, because curved end portion 210 (also referred to as “curved portion 210”) rests against the cam surface 208. This movement of lever 156 will cause the screw 214 to press the blade 232 more or less, depending on the direction of rotation of the adjustment shaft 116. This blade 232 acts on the screw 214 only when the temperature to be controlled is decreasing, i.e., only when the bellows lever 150 is to the left in FIG. 3. This occurs when the contacts 258 and 268 are touching. This movement of the bellows lever 150 in the direction of the bellows 108 happens until there is a snap action of the side arms 252 of the contact blade 242, causing the opening of the contacts 258, 268. So with adjustment of the adjustment shaft 116, the cut out temperature of the thermostat 100 is adjusted. The cut in temperature of the thermostat 100 will not change with the rotation of said shaft 116 since, as noted above, when at the cut in event, the blade 232 separates from the screw 214, and therefore the forces involved at the time of the closing of contacts 258, 268 are of the blade 244 and the gas inside the bellows 108. As these forces do not change with the rotation of the adjustment shaft 116, the cut in temperature of the thermostat 100 is always the same for any angular position of said shaft 112.

The temperatures at which the cut in and the cut out events occur can be adjusted through screw 230, when it is desired to increase or decrease both temperatures, closing and opening of contacts, and through the adjustment screw 278 when it is desired to increase or decrease the differential, which is the difference between the cut in and cut out temperatures. The rotation of screw 278 causes the changes in the cut in temperature, without affecting the cut out temperature. Once the cut in and cut out temperatures of the thermostat 100 for a given position of the adjustment shaft 116 are determined, the end user of the appliance can regulate the temperature of the controlled ambient by rotating the adjustment shaft 116.

Usually rotating the adjustment shaft 116 clockwise causes the temperature to become colder and turning it in a counterclockwise direction causes the temperatures to become warmer. This is achieved because rotating adjustment shaft 116 clockwise causes the curved portion 210 of lever 156 which is in contact with the cam surface 208 of variable radius circular portion 700 of the adjustment shaft 116, moves to the right in FIG. 3. With this the blade 232 will cause more force against the screw 214. As a consequence the balance of forces resulting from gas pressure inside the capillary tube 106 and bellows 108 and forces due to the blades 232 and 244 will be given at a lower value, which corresponds to a lower temperature for the cut out.

Rotating the adjustment shaft 116 in a counterclockwise direction will cause the curved portion 210 of lever 156 to move to the left, resulting in lower force of the blade 232 on screw 214, which means that the balance of forces is give at a greater value, resulting in warmer temperature for the cut out. Optionally, the variable radius of the cam surface 208 of adjustment shaft 116 may have the varying radius reversed, such that rotating adjustment shaft 116 in a clockwise direction causes the cut out temperature of the thermostat be warmer, and turning in the counterclockwise causes the cut out temperature to become colder. This range of adjustment for cut out temperature with the rotation of the adjustment shaft 116 can vary by using different profiles for the cam surface 208 of the adjustment shaft 116, combined with different spring rate for the blade 232 and also with the use of different gases inside the capillary tube 106. With this procedure we can get the correct temperatures for the desired application.

In the embodiment with “alarm,” the principle of operation of the thermostat is above, with the addition of this “alarm” function, which consists in the fact that if the temperature exceeds a predetermined amount beyond the cut in temperature for a given position of the adjustment shaft 116 without the thermostat switch on, then the extra movement that the bellows lever 150 makes to the right (with reference to FIG. 3) causes the central tab 240 of the contact blade 242 to have extra movement to the right such that it will contact tab 302 of the alarm terminal 300 (see FIG. 14), causing a warning light or an audible alarm to be activated to warn the user of the apparatus that the temperature has reached a safety limit for food or a load for an apparatus, at the risk of deterioration. This temperature difference between the normal cut in temperature of the present invention and the “alarm” cut in can be adjusted with the screw 304 that moves the tab 302 of the alarm terminal 300 (see FIG. 14).

For embodiments with an extra terminal to an auxiliary switch (e.g. FIGS. 18 and 19), the thermostat is the same as above, with the addition of an extra function. This extra function is composed of a second pair of contacts between terminals 250 and 500. When in normal operation this pair of contacts is always connected. This pair of contacts will open only when the adjustment shaft 116 is rotated in a counterclockwise direction until the stop, i.e. until the radially outward extending tab 120 of the adjustment shaft 116 touches the inward extending projection 122 of the cover 102.

This is called an “off” position, because in this position of the shaft 116 all the electrics, both between the terminals 250 and 272 and between terminals 250 and 500 will open the contacts, or be disconnected. This extra pair of contacts is used for connecting, for example, an electrical resistance normally used on the door of a refrigerator and used to heat said door in order to avoid condensation of air humidity on the outer surface of said door. Said condensation can occur due to thermal insulation of this part of the refrigerator being not as efficient when compared with the thermal insulation on the other walls of the refrigerator. The electrical resistance must always be ‘on’ when the operation of the refrigeration appliance, in this case a refrigerator, and must be switched off only when you want to shut down the entire unit, which is done via a rotating shaft of the thermostat until “off” position. It is also possible to connect an electrical resistance in the evaporator of a refrigerator, for certain conditions, so that resistance is on whenever the compressor is off, and is off when the compressor is on.

This is achieved by connecting this resistor in parallel with the terminals 250 and 272. Thus when the compressor is working, i.e. when the contacts 258 and 268 are closed, the electrical resistance between them is much smaller than the ohmic resistance of the resistor from the evaporator, then the electric current will pass through the pair of contacts and the resistor will not work. When the contacts open, then the current will start to pass through the resistor. In this case the auxiliary switch will help to cut out this resistor, when the shaft is placed in said “off” position. For this to happen, the electric power should be connected to terminals 272 and 500.

In the case of the resistor coupled to the electrical switch inside the thermostat, its function is to heat the region of the sensor element. It is known that this concept of a thermostat with expansion fluid has the property of controlling the temperature in the coldest portion of the sensing element. That's because the pressure of the gas contained inside the sensor element is corresponding to the coldest temperature of the whole system. In some applications, depending on the location of the body's thermostat, especially when installed inside the refrigeration appliance, the ambient temperature where the thermostat's body is located can be colder than the capillary tube, which is the control area. Using this resistor 600 (see FIG. 20), the body temperature of the thermostat is heated when the thermostat is off, because in this situation the resistor is connected, preventing the thermostat's body from being colder than the capillary tube 106.

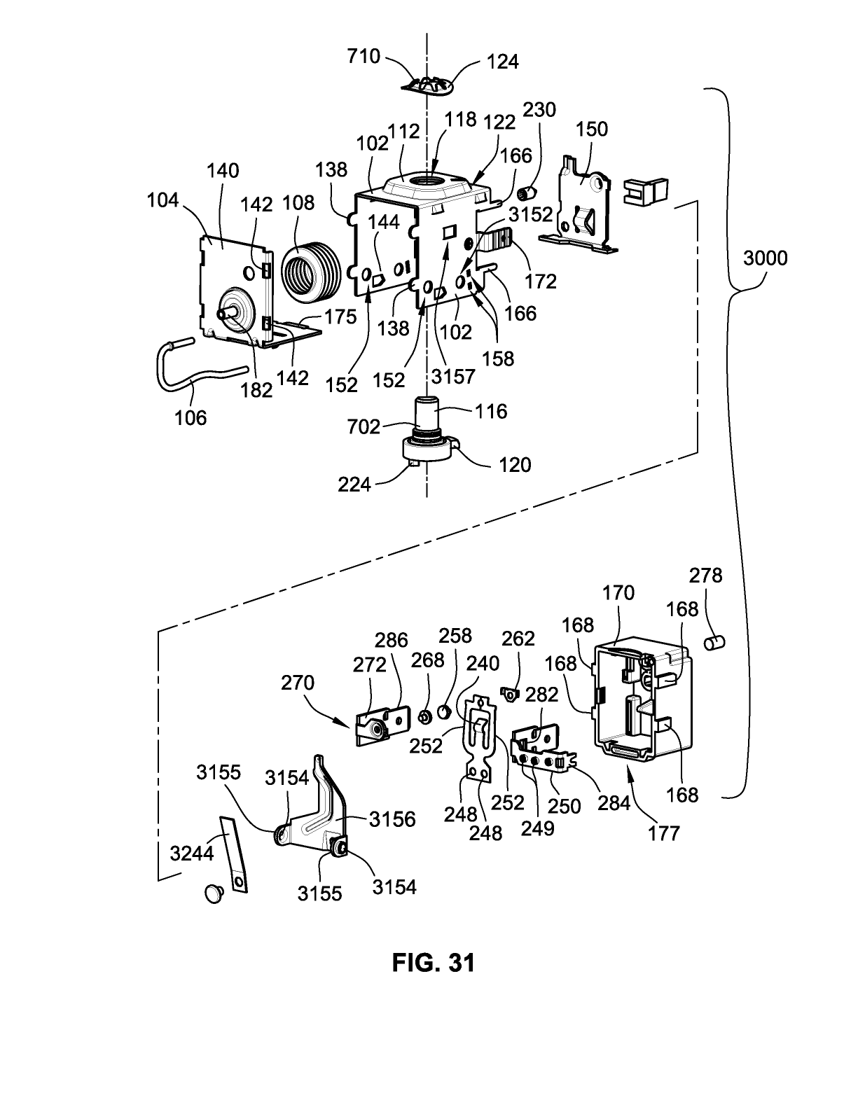

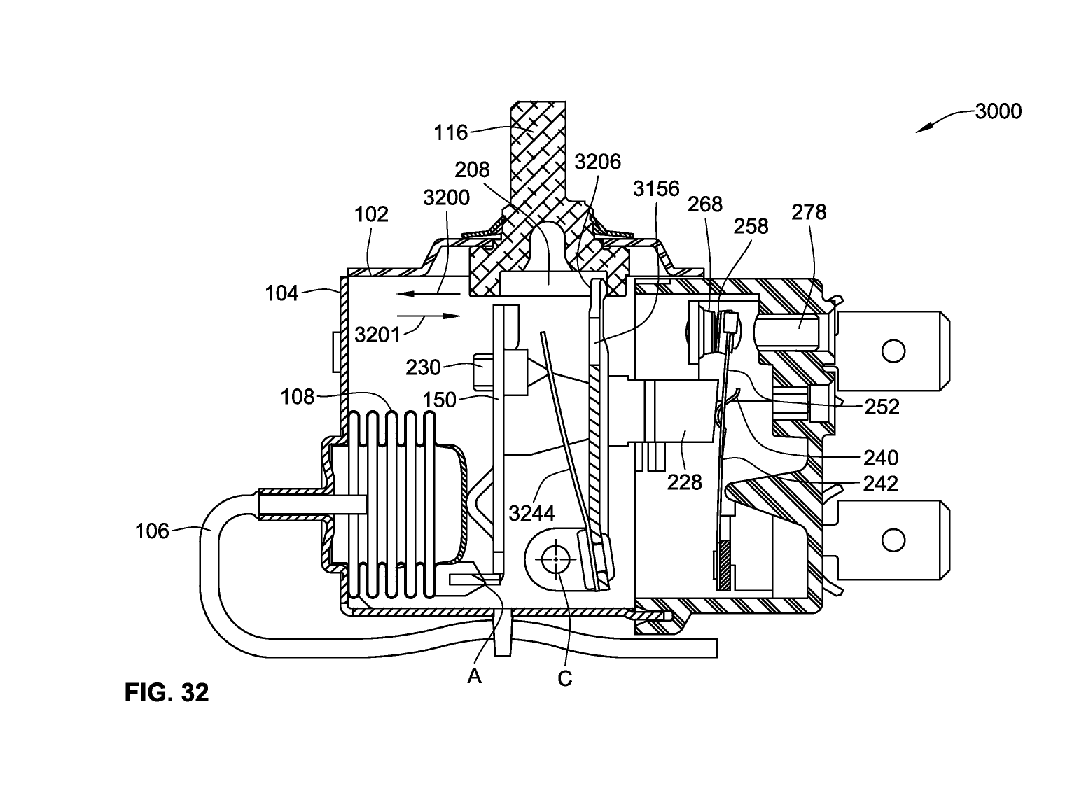

FIGS. 31-32 illustrate a further embodiment of a thermostat 3000 according to an embodiment of the present invention. This embodiment is a constant differential type thermostat. This embodiment maintains a constant differential between the cut in and cut out temperatures but allows for adjustment of these two temperatures. The thermostat 3000 uses a cover 102 and base 104 that are identical to those used in the prior embodiments. Further, the adjustment shaft 116 is identical to those discussed above. The differences between thermostat 100 and thermostat 3000 will now be described.

This thermostat 3000 includes adjustment lever 3156 that is typically stamped metal plate or engineered plastic. The adjustment lever 3156 includes tab 3206 that is a cam follower that cooperates with variable radius cam surface 208 of shaft 116. Again, tab 3206 preferably includes a curved surface that cooperates with cam surface 208 of shaft 116.

Adjustment lever 3156 includes pivot portions 3154 that are mounted in circular cut-outs 3152 formed in cover 102 for rotation about axis C. The pivot portions 3154 are attached to two lateral bended tabs 3155.

Spring blade 3244 is affixed at one end to lever 3156, typically by a rivet, and is biased against adjustment screw 230 carried by bellows lever 150. Rotation of shaft 116 will change the radius of cam surface 208 against which tab 3206 is pressed causing adjustment lever 3156 to rotate about axis C. Rotation of adjustment lever 3156 about axis C adjusts the amount of force that spring blade 3244 will apply to bellows lever 150 via adjustment screw 230. By adjusting the amount of force that adjustment lever 3156, and particularly spring blade 3244, applies to the bellows lever 150, the cut-in and cut-out temperatures of the thermostat 3000 are adjusted.

An inward folded tab 3157 (see FIGS. 6 and 31) is formed on the sides of the cover 11 and acts as a back rest for bellows lever 150.

In FIG. 32, the electrical switch contacts 258, 268 are touching, i.e. the switch of thermostat 3000 is turned on. This means that the compressor of the cooling equipment where the thermostat 3000 is installed is working, i.e. the system is cooling the environment in which the capillary tube 106 is located. As such, the temperature of the environment is decreasing, and therefore, the gas pressure inside the capillary tube 106 and bellows 108 is decreasing. With this, the force of the spring blade 3244 on adjustment screw 230 will be momentarily greater than the force corresponding to the gas inside the bellows 108 that is transferred to screw 230. Now, the bellows lever 150 will begin to shift slightly in the direction of arrow 3200.

With this motion, the actuator 228 attached to bellows lever 150 will also move in a similar direction until blade 242 reaches its tipping point. This will cause the side arms 252 of blade 242 to trigger in the opposite direction until contact 258 touches adjustment screw 278 and opening contacts 258, 268 shutting down the compressor.

With the compressor off, the temperature of the environment sensed by capillary tube 106 will begin to rise, which increases the gas pressure within the capillary tube 106 and bellows 108. The bellows lever 150 will begin to move in the opposite direction illustrated by arrow 3201, overcoming the force of spring blade 3244. The actuator 228 will displace central tab 240 of blade 242 until it exceeds its equilibrium point. At this moment, the side arms 252 shoot in the direction of arrow 3200, i.e. left in FIG. 32. Causing contacts 258, 268 to touch and turning on the compressor. The temperature within the sensed environment begins to cool and the cycle repeats.

The temperature at which these events of opening and closing of the contacts 258, 256 can be adjusted through adjustment screw 230, when it is desired to simultaneously increase or decrease both temperatures, i.e. the cut out and the cut in temperatures. Adjustment of adjustment screw 278 will adjust the differential between the cut-out and cut-in temperatures. Rotation of adjustment screw 278 adjusts the cut-in temperature, without affecting the cut-out temperature. Once the temperatures of the cut-in and cut-out temperatures of the thermostat 3000 have been determined for a given position of the shaft 116, the end user of the appliance can regulate the controlled temperature by rotating the shaft 116.

Typically, rotating shaft 116 clockwise causes the temperatures to become colder and turning the shaft 116 counter-clockwise causes the temperatures to become warmer. This is achieved because rotation of shaft 116 clockwise causes tab 3206 of the adjustment lever 3156 that is in contact with the variable-radius cam surface 208 of shaft 116, moves to the right (i.e. in the direction illustrated by arrow 3201 in FIG. 32). With this, the spring blade 3244 will cause less force against the adjustment screw 230. As a consequence, the balance of forces resulting from gas pressure inside the capillary tube 106 and bellows 108 and the blade spring 3244 will be given at a lower value, which corresponds to a lower temperature for both the cut in and cut out events.

Rotating shaft 116 in the counter-clockwise direction, i.e. the opposite direction will get opposite results and will correspond to a higher temperature for both the cut-in and cut-out events.

Optionally, the cam surface 208 of shaft 116 could vary in radius in the opposite direction to reverse the operation discussed above. Further, the range of temperature variation can be varied by varying the profile of cam surface 208. Further variation can be provided by varying the spring rates of spring blade 3244 as well as varying the gases inside the capillary tube 106 and bellows 108. With these procedures, a correct temperature profile can be obtained for desired applications without requiring significant variations in the configuration of the thermostat 3000.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A thermostat comprising:
a housing including a generally L-shaped main body attached to a generally U-shaped cover to define an internal cavity;
a temperature sensor assembly including a bellows operably fluidly attached to a capillary tube, the bellows and capillary tube defining a sealed cavity storing a working fluid;
a switching arrangement operably actuated by the temperature sensor assembly to open and close a circuit as a result of changes in temperature of the working fluid; and
an adjustment shaft configured to adjust a temperature at which the temperature sensor assembly actuates the switching arrangement to open and close the circuit, the adjustment shaft extending through the housing.

2. The thermostat of claim 1, wherein the U-shaped cover includes a first side portion, a second side portion and a base portion, the first and second side portions are operably coupled to one another by the base portion to form the U-shape with an opening formed between the first and second side portions, the L-shaped main body includes a bellows plate portion and a first leg portion that extends at an angle relative to the bellows plate portion, when assembled, the housing defines a generally open side that is opposite the side provided by the bellows plate portion.

3. The thermostat of claim 2, wherein the first and second side portions extend outward from the base portion and define free distal edges, in an assembled state, the first leg portion of the main body being positioned adjacent the free distal edges of the first and second side portions, a free distal edge of the bellows plate portion being positioned adjacent the base portion.

4. The thermostat of claim 3, wherein each of the first and second side portions includes at least one connecting tab extending from a first edge that extends between the free distal edge and the base portion of corresponding side portion, the bellows plate portion includes a corresponding aperture configured to receive a corresponding one of the connecting tabs therethrough, in an assembled state, the connecting tabs are plastically bent inward and over an outer surface of the bellows plate portion to secure the main body to the cover.

5. The thermostat of claim 4, wherein the assembled housing defines an open side that is opposite the side defined by the bellows plate portion; and
further comprising a switch base attached to the housing adjacent the open side of the housing, each of the first and second side portions of the cover includes at least one switch base connecting tab extending from a second edge, opposite the first edge, the switch base including a corresponding connecting lug for each of the switch base connecting tabs, the connecting lugs extending outward from corresponding sides of the switch base, in the assembled state, the switch base connecting tabs are plastically bent around the corresponding connecting lugs to secure the switch base to the housing.

6. The thermostat of claim 2, wherein each side portion of the cover includes at least one laterally outward extending locating tab that tapers outward when moving in a direction extending away from the base, an end of the locating tabs being farthest from the main body of the cover defining an abutment for locating the housing during installation.

7. The thermostat of claim 2, wherein the base includes an embossed region that extends laterally outward, the embossed region defining an aperture through which the adjustment shaft extends and is rotatable about an adjustment shaft axis, the embossed region including a laterally inward extending projection, the adjustment shaft includes a radially outward extending tab that extends radially outward beyond the inward extending projection, the tab of the adjustment shaft abutting the laterally inward extending projection to limit the amount of rotation of the adjustment shaft within the aperture relative to the cover.

8. The thermostat of claim 1, further comprising a pair of mounting wings, the mounting wings extending laterally outward beyond edges of the side portions, the mounting wings configured to cooperate with an attachment mechanism to secure the thermostat to an appliance.

9. The thermostat of claim 2, wherein at least one of the side portions includes a laterally outward offset ground terminal formed therein, the ground terminal being a continuous piece of material with the rest of the corresponding side portion.

10. The thermostat of claim 3, wherein the bellows portion includes bent reinforcement flaps forming opposed edges of the bellows plate portion that extend away from the leg portion of the main body, the reinforcement flaps being spaced laterally apart from one another a distance greater than the first and second side portions of the cover, the first and second side portions of the cover being received between the reinforcement flaps when the housing is in an assembled state such that each reinforcement flap overlaps the outer surface of the adjacent one of the first and second side portions.

11. A thermostat comprising:
a housing;
a switching arrangement configured to open and close a circuit; and
a temperature sensor assembly including a bellows operably fluidly attached to a capillary tube, the bellows and capillary tube defining a sealed cavity storing a working fluid, the temperature sensor assembly configured to actuate the switching arrangement as a result of changes in temperature of the working fluid;
an adjustment shaft configured to adjust a temperature at which the temperature sensor actuates the switching arrangement, the adjustment shaft extending through the housing, the adjustment shaft including a recess defining a radially inward facing cam surface that bounds the recess, the radially inward facing cam surface having a varying radius relative to a rotational axis of the adjustment shaft; and
the switching arrangement including a cam follower that cooperates with the cam surface to adjust a temperature setting at which the temperature sensor actuates the switching arrangement.

12. The thermostat of claim 11, wherein the adjustment shaft includes an enlarged portion that is sized larger than an aperture in the housing through which the adjustment shaft extends, the enlarged portion having a top surface that abuts an inner surface of the housing surrounding the aperture, the recess of the adjustment shaft that receives the cam follower of the switching arrangement being formed in an opposite end of the enlarged portion.

13. The thermostat of claim 12, wherein the adjustment shaft includes a reduced diameter cylindrical portion offset from the enlarged portion, the reduced diameter cylindrical portion sized to mate with the aperture through the housing.

14. The thermostat of claim 11, further comprising a bush beaded to the cover, the adjustment shaft extending through the bush, the bush including an enlarged cylindrical portion that is sized larger than an aperture in the housing through which the adjustment shaft extends, the bush including an axially extending annular flange that extends through the aperture in the housing, when assembled, the axially extending annular flange is beaded radially outward and over an inner surface of the housing adjacent the aperture to secure the bush in the aperture in the housing.

15. The thermostat of claim 14, wherein the bush further includes a second axially extending cylindrical portion that is on an opposite side of the bush as the axially extending annular flange;
the adjustment shaft includes a circular recess; and
the second axially extending cylindrical portion is radially inwardly beaded into the circular recess of the adjustment shaft to axially secure the adjustment shaft within the bush.

16. The thermostat of claim 15, wherein an inner surface of the housing adjacent the aperture through which the adjustment shaft extends includes a plurality of recesses, the axially extending annular flange engaging the recesses during the beading process.

17. The thermostat of claim 11, further comprising a driver operably attachable to the adjustment shaft, the driver being configured to be attached to the adjustment shaft in more than one angular orientation about the rotational axis of the adjustment shaft, the driver being configured to engage a knob and to translate rotation motion of the knob to the adjustment shaft.

18. A method of assembling a thermostat comprising:
attaching a U-shaped cover to an L-shaped main body to form a housing;
securing an adjustment shaft to the housing for rotation;
attaching a temperature sensor assembly to the housing;
attaching, operably, a switching arrangement to the housing and the temperature sensor assembly such that the temperature sensor assembly actuates the switching arrangement in response to sensed changes in temperature; and
connecting the switching arrangement to the adjustment shaft in such a manner that rotation of the adjustment shaft adjusts the temperature at which the temperature sensor assembly actuates the switching arrangement.

19. The method of claim 18, wherein the adjustment shaft includes a recess bound by a radially inward directed cam surface, the cam surface having a varying radius relative to a rotational axis of the adjustment shaft, the switching arrangement includes a cam follower;
the step of connecting the switching arrangement to the adjustment shaft includes inserting the cam follower into the recess and biasing the cam follower into contact with the cam surface such that rotation of the adjustment shaft adjust the position of the cam follower as well as a temperature setting of the thermostat.

20. The method of claim 18, wherein the U-shaped cover includes a first side portion, a second side portion and a base portion, the first and second side portions are operably coupled to one another by the base portion to form the U-shape with an opening formed between the first and second side portions, the L-shaped main body includes a bellows plate portion and a first leg portion that extends at an angle relative to the bellows plate portion, when assembled, the housing defines a generally open side that is opposite the side provided by the bellows plate portion, the first and second side portions extend outward from the base portion and define free distal edges, each of the first and second side portions includes at least one connecting tab extending from a first edge that extends between the free distal edge and the base portion of the corresponding side portion, the bellows plate portion includes a corresponding aperture configured to receive a corresponding one of the connecting tabs therethrough;
the step of attaching a U-shaped cover to an L-shaped main body to form a housing includes inserting the connecting tabs into the apertures formed in the bellows plate portion, plastically bending the connecting tabs inward and over an outer surface of the bellows plate portion to secure the main body to the cover, with the first leg portion of the main body being positioned adjacent the free distal edges of the first and second side portions, a free distal edge of the bellows plate portion being positioned adjacent the base portion.
